(19) United States
(12) Patent Application Publication
(10) Pub. No.: US 2020/0295632 A1
(43) Pub. Date: Sep. 17, 2020

(54) IDENTIFICATION METHOD FOR IDENTIFYING TYPE OF BRUSHLESS DC MOTOR, IDENTIFICATION DEVICE, AND BRUSHLESS DC MOTOR

(71) Applicant: Nidec Corporation, Kyoto (JP)

(72) Inventor: Hideyuki TAKEMOTO, Kyoto (JP)

(21) Appl. No.: 16/767,610

(22) PCT Filed: Nov. 14, 2018
(86) PCT No.: PCT/JP2018/042167

§ 371 Date: May 28, 2020

(30) Foreign Application Priority Data
Nov. 29, 2017 (JP) 2017-229275

(51) Int. Cl. H02K 11/33

(52) U.S. Cl. CPC H02K 11/33

(57) ABSTRACT

A brushless DC motor identification method includes supplying an input voltage from the identification device to a brushless DC motor via a power supply line, the brushless DC motor including at least one resistor connected between the power supply line and a GND line, an inverter that drives a motor, and a switching circuit that switches connection and disconnection between the power supply line and the inverter, disconnecting the inverter from the power supply line via the switching circuit, reading a resistance value of the at least one resistor in a state where driving of the inverter is stopped, and identifying information on the brushless DC motor based on the read resistance value of the at least one resistor.

### CROSS REFERENCE TO RELATED APPLICATIONS

This is a U.S. national stage of PCT Application No. PCT/JP2018/042167, filed on Nov. 14, 2018, and claiming priority under 35 U.S.C. § 119(a) and 35 U.S.C. § 365(b) from Japanese Application No. 2017-229275, filed Nov. 29, 2017; the entire disclosures of which are hereby incorporated herein by reference.

### 1. FIELD OF THE INVENTION

The present disclosure relates to an identification method for identifying the type of a brushless DC motor, an identification device, and a brushless DC motor.

### 2. BACKGROUND

Many electronic devices include, for example, a fan motor as a cooling device for releasing heat generated inside to the outside. In an electronic device, a fan motor is electrically connected to a system controller and operates under the control of the system controller.

In a conventional identification method, a fan motor and a system controller communicate with each other to obtain fan identification information. For example, the mode is switched from a normal mode to a command mode, and the fan motor and the system controller transmit and receive commands via a power supply line, a pulse width modulation (PWM) line, and a tachometer (TACH) line. The system controller obtains the fan identification information by handshaking and determines compatibility with the fan motor. In this case, both the system controller and the fan require complicated control software such as switching between the normal mode and the command mode.

A conventional motor drive has a regenerative resistor and an operation switch, and has a regenerative power consumption unit connected between DC buses. The operation switch is controlled by comparing the drive voltage and the regenerative voltage. By turning on the operation switch, it is possible to consume the regenerative power from the motor by the regenerative resistor.

In the above-described conventional art, a method for more easily identifying information on a brushless DC motor has been desired.

### SUMMARY

An example embodiment of an identification method of the present disclosure is an identification method to identify information on a brushless DC motor output from the brushless DC motor. The identification method is used by an identification device. The brushless DC motor includes at least one resistor connected between a power supply line and a GND line, an inverter that drives a motor, and a switching circuit that switches connection and disconnection between the power supply line and the inverter. The method includes supplying an input voltage from the identification device to the brushless DC motor via the power supply line, disconnecting the inverter from the power supply line via the switching circuit, reading a resistance value of the at least one resistor in a state where driving of the inverter is stopped, and identifying information on the brushless DC motor based on the read resistance value of the at least one resistor.

An example embodiment of an identification device of the present disclosure is an identification device to identify information on a brushless DC motor. The brushless DC motor includes at least one resistor connected between a power supply line and a GND line, an inverter that drives a motor, and a switching circuit that switches connection and disconnection between the power supply line and the inverter. The identification device includes a power supply terminal that supplies an input voltage to the brushless DC motor via the power supply line, and a controller to identify information on the brushless DC motor. The controller supplies the input voltage to the brushless DC motor, and in a state where the inverter is disconnected from the power supply line via the switching circuit to stop driving of the inverter, reads the resistance value of the at least one resistor, and identifies the information on the brushless DC motor based on the read resistance value of the at least one resistor.

An example embodiment of a brushless DC motor of the present disclosure includes a circuit board, a power supply terminal to supply an input voltage from the outside, the power supply terminal being on the circuit board, an inverter that drives a motor, at least one resistor connected between a power supply line connected to the power supply terminal and a GND line, the at least one resistor having a resistance value larger than a DC resistance of the motor, and a switching circuit to switch connection and disconnection between the power supply line and the inverter, the switching circuit including an under voltage lockout circuit that disconnects the inverter from the power supply line when the level of the input voltage is equal to or lower than a threshold. In a state where the input voltage at the level equal to or lower than the threshold is supplied via the power supply terminal and where the inverter is disconnected from the power supply line by the switching circuit to stop driving of the inverter, a current including information indicating the resistance value of the at least one resistor flows through the power supply terminal.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a flowchart of an identification method to identify the type of a brushless DC motor according to an example embodiment of the present disclosure.

FIG. 2 is a block diagram schematically showing examples of typical block configurations of a user system 100 and a brushless DC motor 200 according to a first example embodiment of the present disclosure.

FIG. 3 is a block diagram schematically showing an example of a block configuration inside the user system 100.

FIG. 4 is a block diagram schematically showing another example of a block configuration of the user system 100 and the brushless DC motor 200 according to the first example embodiment of the present disclosure.

FIG. 5 is a flowchart of an identification method of identifying the type of the brushless DC motor 200 according to the first example embodiment of the present disclosure.

FIG. 6 is a diagram illustrating a table used to identify the type of the brushless DC motor 200.

FIG. 7 is a flowchart of a further identification method to identify the type of the brushless DC motor 200 according to the first example embodiment of the present disclosure.

FIG. 8 is a block diagram schematically showing a variation of a block configuration of the user system 100 and the brushless DC motor 200 according to the first example embodiment of the present disclosure.

FIG. 9 is a flowchart showing a specific example of a process of step S200 for reading an identification resistance value.

FIG. 10 is a diagram illustrating a table used to identify the type of a brushless DC motor, using an ASCII code as unique information.

FIG. 11A is a circuit diagram showing a circuit configuration of a variation of identification resistance circuitry 250.

FIG. 11B is a circuit diagram showing a circuit configuration of a variation of the identification resistance circuitry 250.

FIG. 11C is a circuit diagram showing a circuit configuration of a variation of the identification resistance circuitry 250.

FIG. 12A is a flowchart showing another specific example of the process of step S200 of reading the identification resistance value.

FIG. 12B is a flowchart showing another specific example of the process of step S200 of reading the identification resistance value.

FIG. 13 is a block diagram schematically showing examples of typical block configurations of a user system 100 and a brushless DC motor 200 according to a second example embodiment of the present disclosure.

FIG. 14 is a circuit diagram showing an exemplary circuit configuration of an under voltage lockout circuit 272.

FIG. 15 is a flowchart of an identification method for identifying the type of the brushless DC motor 200 according to the second example embodiment of the present disclosure.

FIG. 16 is a block diagram schematically showing examples of typical block configurations of a user system 100, an identification device 100A, and a brushless DC motor 200 according to a third example embodiment of the present disclosure.

FIG. 17 is a block diagram schematically showing another example of a block configuration of the user system 100, the identification device 100A, and the brushless DC motor 200 according to the third example embodiment of the present disclosure.

### DETAILED DESCRIPTION

Hereinafter, example embodiments of identification methods and identification devices to identify the type of a brushless DC motor according to the present disclosure will be described in detail with reference to the accompanying drawings. However, in order to avoid the following description from being unnecessarily redundant and to make it easier for those skilled in the art to understand, a detailed description more than necessary may be omitted. For example, a detailed description of a well-known item or a redundant description of substantially the same configuration may be omitted. In addition, example embodiments of the present disclosure are not limited to the devices or methods illustrated below. For example, one example embodiment can be combined with another example embodiment.

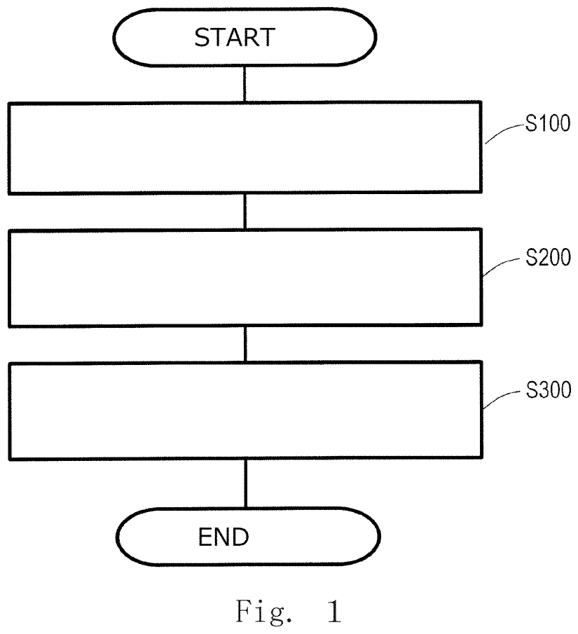

Before describing an example embodiment of the present disclosure, overview of an identification method according to the present disclosure will be described with reference to FIG. 1. FIG. 1 shows a flowchart of an identification method for identifying the type of a brushless DC motor according to the present disclosure.

The identification method according to the present disclosure is an identification method used for an identification device that identifies information on a brushless DC motor output from the brushless DC motor. The brushless DC motor is typically a two-wire motor having a power supply terminal and a GND terminal, and includes at least one resistor connected between the power line and the GND line. When a power supply voltage is supplied to the brushless DC motor via the power supply terminal, in a state where the inverter is stopped (off), an identification current including identification information indicating a resistance value of at least one resistor flows through the power supply terminal. In this specification, at least one resistor may be referred to as an “identification resistor”, and a resistance value thereof may be referred to as an “identification resistance value”.

An identification method according to the present disclosure includes a step of supplying a power supply voltage from an identification device to a brushless DC motor via a power supply line (step S100), a step of reading a resistance value of at least one resistor in a state where the inverter of the brushless DC motor is stopped (step S200), and a step of identifying information on the brushless DC motor based on the read resistance value of at least one resistor (step S300).

According to the identification method according to the present disclosure, it is possible to identify various types of information on a brushless DC motor output from the brushless DC motor. Such information includes, for example, brushless DC motor identification information, brushless DC motor serial number, lot number, rated current or rated voltage, and the like. In the present specification, example embodiments for identifying the type of a brushless DC motor, among various types of information related to the brushless DC motor, will be mainly described.

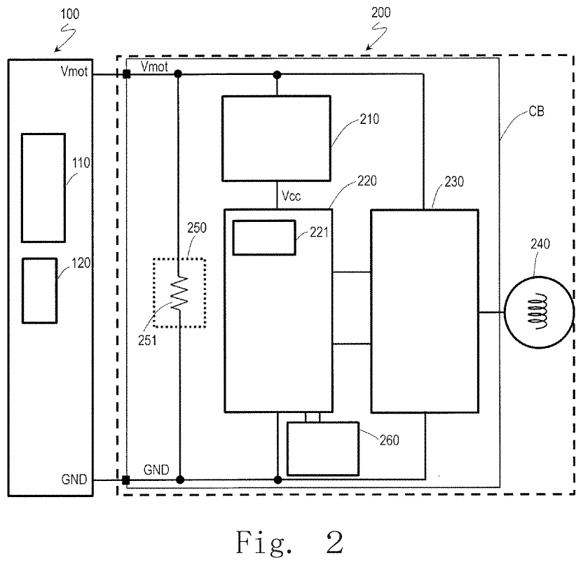

FIG. 2 schematically shows examples of typical block configurations of the user system 100 and the brushless DC motor 200 according to the present example embodiment. In this specification, the structure and the operation of the brushless DC motor 200 will be described using a fan motor as an example. The brushless DC motor of the present disclosure includes an inner rotor type or outer rotor type motor. The brushless DC motor 200 is not limited to a fan motor, and is a brushless DC motor used for various applications. The brushless DC motor 200 is, for example, a motor used for home appliances such as an air conditioner or a washing machine, and a vehicle-mounted motor.

The user system 100 is electrically connected to the brushless DC motor 200. The user system 100 can supply power to the brushless DC motor 200. The user system 100 can be mounted on a brushless DC motor production management system in a factory that produces a wide variety of products. The user system 100 is a system in an electronic device or a vehicle-mounted system on which the brushless DC motor 200 can be mounted. For example, the brushless DC motor 200 is preferably mounted on an electronic device such as a server, a main body of a desktop personal computer, or a game machine. For example, when brushless DC motors 200 with different specifications are produced at the same location, the user system 100 is part of a series of inspection systems. Alternatively, when the brushless DC motor 200 is mounted as a fan motor on the main body of a server or a desktop personal computer, the user system 100 is the entire system or part of the system including various electronic components mounted on a motherboard.

The user system 100 includes, for example, a controller 110 and a memory 120. The user system 100 according to the present example embodiment has a function of identifying the type of the brushless DC motor 200, as described later. In other words, the user system 100 can be used as an identification device for identifying the type of the brushless DC motor 200. Therefore, in this specification, the user system 100 may be referred to as an identification device 100 in some cases.

The controller 110 mainly controls the entire user system 100 and can control power supply to the brushless DC motor 200. The controller 110 can further identify the type of the brushless DC motor 200. The controller 110 is, for example, a semiconductor integrated circuit such as a micro control unit (MCU) or a field programmable gate array (FPGA).

The memory 120 is, for example, a writable memory (for example, PROM), a rewritable memory (for example, flash memory), or a read-only memory. The memory 120 stores, for example, a control program having a command group for causing the controller 110 to identify the type of the brushless DC motor 200. For example, the control program is temporarily expanded in a RAM (not shown) at the time of booting. The memory 120 does not need to be externally attached to the controller 110, and may be mounted on the controller 110. The controller 110 including the memory 120 is, for example, the above-described MCU.

The user system 100 includes a Vmot terminal and a GND terminal as connection terminals with the brushless DC motor 200. The Vmot terminal is a terminal for a motor power supply. For example, a motor power supply voltage Vmot in a range from 7.0 to 13.8 V is supplied to the brushless DC motor 200 from the Vmot terminal.

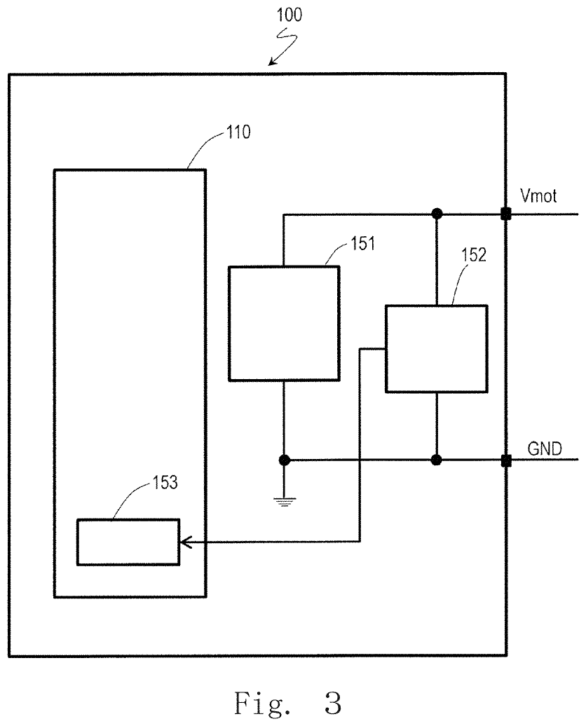

FIG. 3 schematically shows an example of a more detailed block configuration inside the user system 100.

The user system 100 further includes, for example, a DC power supply 151, a resistance value detector 152, and a discriminator 153. When referring to the internal block configuration of the user system 100 or the identification device 100, the components of the controller 110, the DC power supply 151, the resistance value detector 152, and the discriminator 153 may be collectively referred to simply as “controller 110”.

The DC power supply 151 mainly generates a motor power supply voltage Vmot (for example, 7.0 to 13.8 V) to be supplied to the brushless DC motor 200 during normal motor driving. The normal motor driving means driving the motor in a state where the inverter 230 of the brushless DC motor 200 is operated by supplying power to the inverter 230.

The resistance value detector 152 can generate a power supply voltage to be supplied to the brushless DC motor 200 and supply the power supply voltage to the brushless DC motor 200, in identifying the type of the brushless DC motor 200. The power supply voltage may be lower than the motor power supply voltage Vmot generated by the DC power supply 151. Furthermore, the resistance value detector 152 can detect the identification resistance value of the brushless DC motor 200 based on the identification current flowing through the power supply line and the power supply voltage, in identifying the type of the brushless DC motor 200.

The discriminator 153 identifies the type of the brushless DC motor 200 based on the identification resistance value of the brushless DC motor detected by the resistance value detector 152. The discriminator 153 is typically mounted on the controller 110.

FIG. 2 is referred to again.

The brushless DC motor 200 is, for example, a DC fan having an impeller. The brushless DC motor 200 is, for example, an axial fan, a centrifugal fan, a cross flow fan, or a sirocco fan. The brushless DC motor 200 typically includes a regulator 210, a motor drive IC 220, an inverter 230, a circuit board CB on which those electronic components are mounted, a coil 240, identification resistance circuitry 250 having at least one resistor 251, and a Hall element 260. For example, the regulator 210, the motor drive IC 220, the inverter 230, and the Hall element 260 constitute a drive circuit for energizing the coil 240 to drive the motor.

The regulator 210 reduces the motor power supply voltage Vmot of, for example, 13.8 V to generate a power supply voltage Vcc (for example, 5 V) for the motor drive IC 220. In the brushless DC motor 200, the power supply voltage Vcc supplied to the motor drive IC 220 is preferably generated based on the motor power supply voltage Vmot. As a result, it is not necessary to provide a terminal for the power supply voltage Vcc in the brushless DC motor 200, and the number of terminals and lead wires can be reduced. However, the power supply voltage Vcc may be supplied from the user system 100 to the brushless DC motor 200 separately from the motor power supply voltage Vmot.

The motor drive IC 220 includes, for example, an MCU 221 and is connected to the inverter 230. The MCU 221 generates a PWM signal for controlling rotation of the motor. The motor drive IC 220 generates a control signal for controlling the inverter 230 according to the PWM signal and outputs the control signal to inverter 230.

The MCU 221 incorporates a general timer function. By using this function, the MCU 221 can stop generating the PWM signal until a predetermined time elapses from the start of application of the power supply voltage Vcc. The predetermined time is, for example, about 0.1 s. Thus, driving of the inverter 230 can be stopped from the start of application of the power supply voltage Vcc until the predetermined time elapses.

The motor drive IC 220 monitors the rotation speed of the motor based on, for example, the output from the Hall element 260, and generates a PWM signal according to the rotation speed of the motor. The output method is, for example, two pulses per rotation. However, a technique that does not use a Hall element is known. When such a technique is employed, the Hall element 260 is not essential.

The inverter 230 is electrically connected to motor drive IC 220 and coil 240 of the motor. The inverter 230 converts the power of the motor power supply to the power to be supplied to the fan motor under the control of the motor drive IC 220, and energizes the coil 240 of the motor.

The coil 240 is a winding of the motor.

The identification resistance circuitry 250 has at least one resistor 251. In one example embodiment, at least one resistor 251 is one resistor. For example, the identification resistor 251 has a resistance value that is ten times or more the DC resistance of the motor. With a large resistance value, it is possible to suppress the power loss due to the identification resistor 251 during normal motor driving. As the identification resistor 251, for example, a resistor having a resistance value in a range from 1 kΩ to 100 kΩ can be used.

The resistance value of the identification resistor 251 differs for each type of a plurality of brushless DC motors. As the unique information of the brushless DC motor, a different unique resistance can be assigned to the identification resistor 251 for each type of the brushless DC motors.

For example, an identification resistor can be assigned as unique information of a brushless DC motor for each supplier that manufactures brushless DC motors. For example, a 20 kQ identification resistor can be assigned to a supplier A, a 30 kQ identification resistor can be assigned to a supplier B, and a 40 kQ identification resistor can be assigned to a supplier C. Further, identification resistors having resistance values different from these can be assigned to a plurality of suppliers, respectively.

For example, an identification resistor can be assigned as unique information for each product lot. For example, a 20 kQ identification resistor can be assigned to a product lot number A, a 30 kQ identification resistor can be assigned to a product lot number B, and a 40 kQ identification resistor can be assigned to a product lot number C. Further, a different identification resistance value can be assigned to each of a plurality of product lot numbers. Thus, there are as many types of the plurality of brushless DC motors as, for example, the number of suppliers or as the number of product lots to be managed.

The brushless DC motor 200 includes, for example, a circuit board CB on which a Vmot terminal and a GND terminal are disposed corresponding to the terminals on the user system 100 side.

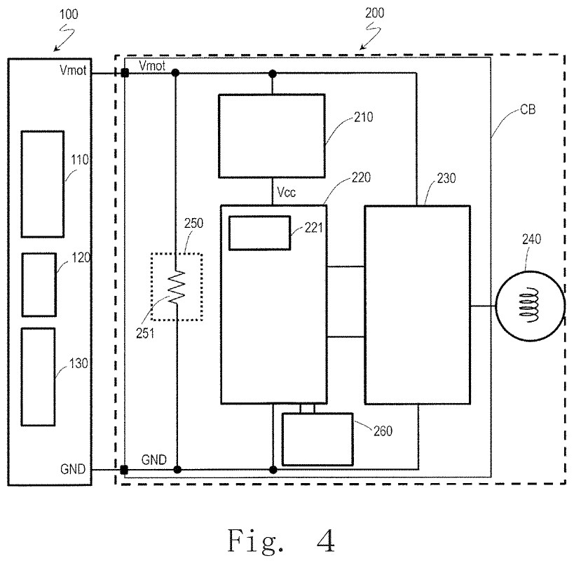

FIG. 4 schematically shows other exemplary block configurations of the user system 100 and the brushless DC motor 200.

The user system 100 may further include a light emitting element 130. The light emitting element 130 has, for example, a plurality of light emitted diodes (LEDs). The plurality of LEDs are notification devices that notify the identification result of the type of the brushless DC motor 200. For example, a plurality of LEDs can be provided by the number of types of a plurality of brushless DC motors. For example, if there are two types of brushless DC motors of suppliers A and B, two LEDs with different emission colors can be provided. For example, a red LED for supplier A and a blue LED for supplier B can be used.

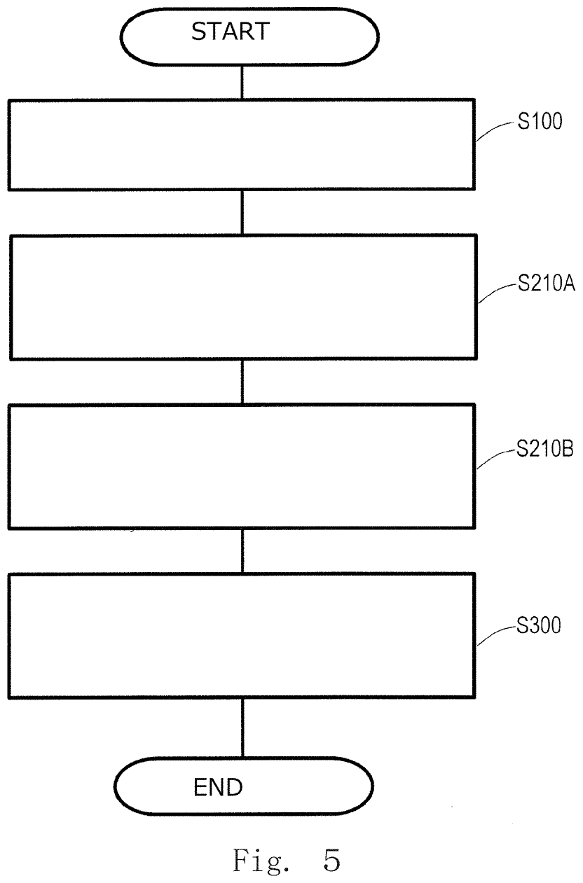

FIG. 5 shows a flowchart of an identification method for identifying the type of the brushless DC motor 200 according to the present example embodiment.

The identification method according to the present example embodiment is a method used for the identification device 100, for example. In the process of manufacturing a wide variety of products having motors, it is generally necessary to identify the type of the brushless DC motor 200 in order to prevent mixing of different types of motors. For example, the identification method of the present disclosure is suitably used for a method of inspecting compatibility of the brushless DC motor 200 with the user system 100 when manufacturing a product in a factory. For example, a step of checking compatibility of the brushless DC motor 200 can be incorporated as part of the product manufacturing process.

First, in a state where the terminals of the identification device 100 (user system 100) and the brushless DC motor 200 are electrically connected, an identification power supply voltage is supplied from the identification device 100 to the brushless DC motor 200. For example, a power supply voltage of 13.8 V generated by the resistance value detector 152 is supplied to the brushless DC motor 200 as an identification power supply voltage. However, the motor power supply voltage Vmot may be supplied as the identification power supply voltage from the DC power supply 151 to the brushless DC motor 200 in the same manner as that during normal driving.

Generation of a PWM signal is stopped using the timer function of the MCU 221 of the motor drive IC 220 from the start of application of the identification power supply voltage until a predetermined time (for example, 0.1 s) elapses. Thereby, driving of the inverter 230 is stopped. In this state, although the identification power supply voltage is supplied to the inverter 230 but the PWM signal is not input, driving of the inverter 230 remains stopped. As a result, power is not supplied from the inverter 230 to the coil 240 of the motor.

With use of the identification device 100, an identification resistance value is read as unique information of the brushless DC motor 200 in state where the inverter 230 is stopped. More specifically, an identification resistance value is read as unique information of the brushless DC motor 200 with use of the resistance value detector 152 of the identification device 100 in a state where the inverter 230 is stopped. When an identification power supply voltage is applied to the brushless DC motor 200, a current flowing through the identification resistor 251 according to the identification resistance value flows through the resistance value detector 152. This is because the motor current does not flow through the motor. That is, only the identification current including the information on the identification resistance value flows to the resistance value detector 152. By measuring the identification current, the resistance value detector 152 can detect the identification resistance value from the current value and the identification power supply voltage. On the other hand, when the inverter 230 is driven, the motor current flows and the current fluctuation increases, so that it is difficult to detect the identification resistance value.

The discriminator 153 refers to a table and identifies the type of the motor based on the detected identification resistance value.

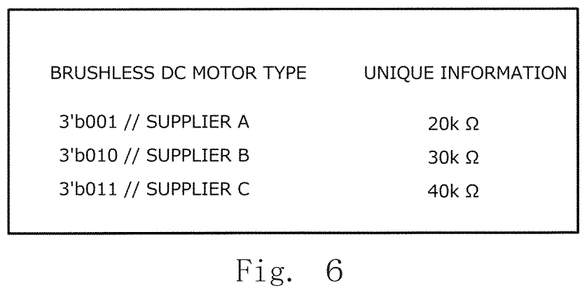

FIG. 6 illustrates a table used to identify the type of the brushless DC motor 200. The table is a look-up table (LUT) for associating a plurality of brushless DC motor types with pieces of unique information of the plurality of brushless DC motors. The unique information of the brushless DC motor indicates the identification resistance value. The table is stored in the memory 120, for example. As described above, a plurality of types of brushless DC motors exist, for example, for respective suppliers, and for example, there are three types of suppliers A, B, and C. For example, the type of motor can be represented by, for example, a 3-bit digital signal.

For example, the discriminator 153 may include an AD converter (not shown). The discriminator 153 converts the identification resistance value (analog value) detected by the resistance value detector 152 into a digital signal. The unique information of the brushless DC motor can also be represented by a digital value having the same bit width as the resolution of AD conversion. Note that the AD converter may be mounted on the resistance value detector 152 in the preceding stage.

When the identification of the type of the brushless DC motor by the identification device 100 is completed, the stopped state of the inverter 230 is released. Thereafter, for example, the motor power supply voltage Vmot is supplied from the DC power supply 151 to the brushless DC motor 200. When a PWM signal is provided from the motor drive IC 220 to the inverter 230, the inverter 230 starts driving of the motor in a normal state.

According to the identification method of the present example embodiment, it is possible to identify the type of the brushless DC motor 200 in a state where the inverter 230 is stopped. Identification of the type of the brushless DC motor 200 can be performed separately from the normal driving of the motor, so that the load on the identification device 100 can be reduced. Furthermore, communication by handshaking between the identification device 100 and the brushless DC motor 200 as in the related art is unnecessary. In addition, an existing power supply terminal can be used, and it is not necessary to newly provide a dedicated terminal for identification. Product cost can be reduced by reducing the number of parts. Since input and output terminals such as a PWM terminal and a TACH terminal are not particularly required for identification, an advantage is obtained particularly for identifying the type of a two-wire motor.

The identification method of the present disclosure is preferably used not only at the time of product manufacturing but also, for example, when replacing a failed brushless DC motor with a new brushless DC motor. It is possible to check whether or not the replaced brushless DC motor is compatible with the system. Also, for example, each product provided to a brushless DC motor is connected to the Internet. The so-called Internet of Things (IoT) is realized. For example, a supplier of an individual product equipped with a brushless DC motor can identify a product equipped with a specific brushless DC motor by analyzing big data including the unique information of the brushless DC motor. This can stabilize the quality, for example, by preventing occurrence of defects.

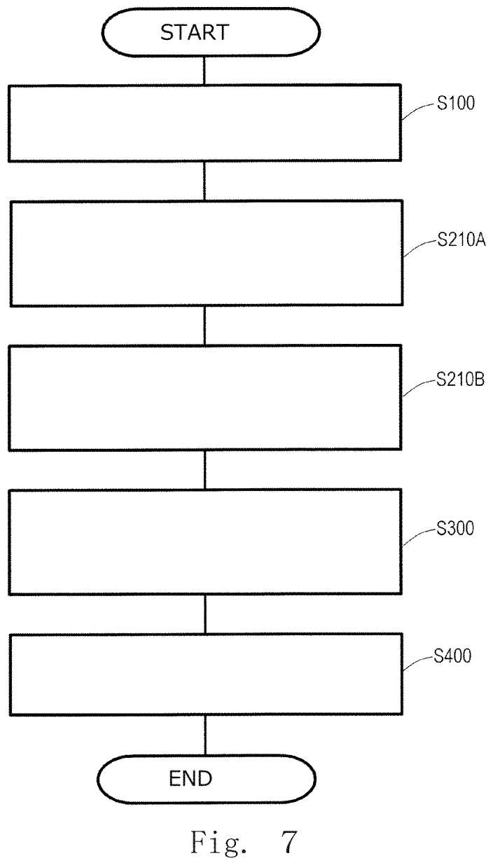

FIG. 7 shows a further specific example of a flowchart of the identification method for identifying the type of the brushless DC motor 200.

As shown in FIG. 7, the identification method according to the present example embodiment can further include a step S400 of notifying a result of identifying the type of the brushless DC motor 200.

As an example of the notifying method, it is possible to notify a result of identifying the type of the brushless DC motor 200 using the light emitting element 130 (for example, a plurality of LEDs) shown in FIG. 4. The controller 110 of the identification device 100 causes the LED assigned to the identification target brushless DC motor 200, among a plurality of LEDs assigned to the respective types of brushless DC motors, to emit light based on the result of identifying the type of the brushless DC motor 200. Note that the light emitting element is not limited to an LED, and may be an element that gives notice by light.

For example, a red LED can be assigned to a supplier A, a blue LED can be assigned to a supplier B, and a green LED can be assigned to a supplier C. When the controller 110 of the identification device 100 identifies a brushless DC motor of the supplier C, the controller 110 can cause a green LED to emit light. Thus, for example, a factory worker can visually recognize whether or not the brushless DC motor to be identified is a motor of the supplier C.

As another example, a result of identifying the type of the brushless DC motor 200 can be notified using a display device (for example, a liquid crystal display) or a speaker. For example, the identification result can be displayed on a liquid crystal display as character information. For example, it is possible to change the pitch of the sound for each type of a plurality of brushless DC motors and make the speaker sound.

As another example, the controller 110 of the identification device 100 may temporarily write the identification result to the memory 120 or transmit it to another apparatus or device that needs the identification result. These modes are also examples of notifying the identification result.

In addition to the type information of the brushless DC motor, various types of information on the brushless DC motor such as the serial number, lot number, input power, input current, input voltage, motor temperature, rated current or rated voltage of the brushless DC motor can be associated with the identification resistance value. With the identification resistor associated with such information being provided on the brushless DC motor side, the identification device 100 can acquire various types of information regarding the brushless DC motor.

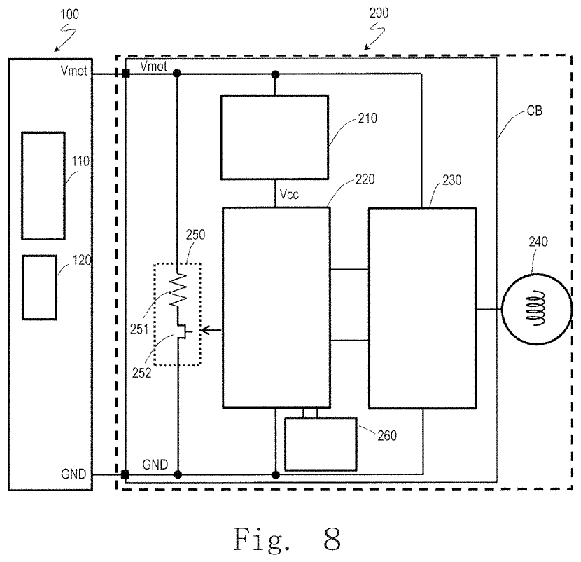

FIG. 8 schematically shows variations of the block configurations of the user system 100 and the brushless DC motor 200 according to the present example embodiment.

In the configuration of the variation, the identification resistance circuitry 250 includes an identification resistor 251 and a switch element 252 connected between one end of the identification resistor 251 and the GND line. However, the switch element 252 may be connected between the other end of the identification resistor 251 and the power supply line. As the switch element 252, for example, a semiconductor switch element of a bipolar or unipolar transistor can be used.

For example, the motor drive IC 220 can control on/off of the switch element 252 at predetermined time intervals. The predetermined time interval is, for example, 1 ms.

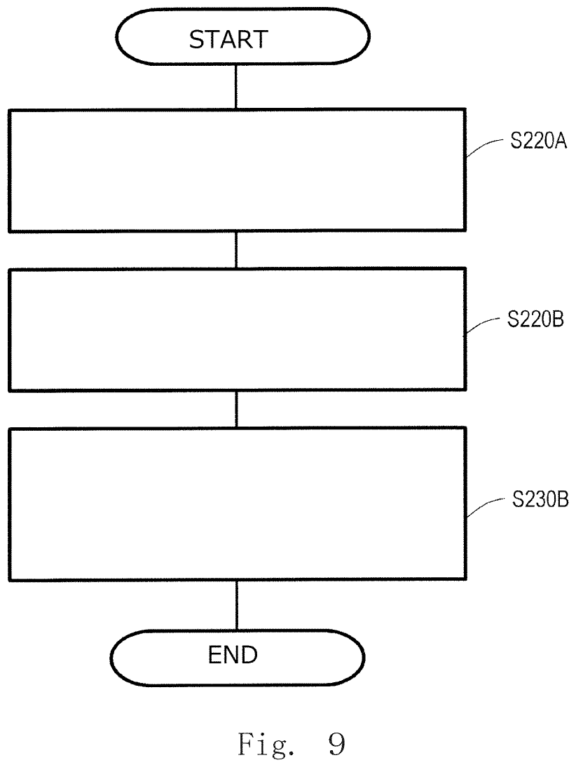

FIG. 9 shows a more detailed flowchart of step S200 for reading the identification resistance value in the processing flow of the identification method for identifying the type of the brushless DC motor 200 according to the present variation.

As in step S210A, generation of a PWM signal is stopped using the timer function of the MCU 221 of the motor drive IC 220 from the start of application of the identification power supply voltage until a predetermined time (for example, 0.1 s) elapses.

In a state where driving of the inverter 230 is stopped, the switch element 252 is turned on/off by the motor drive IC 220. For example, the motor drive IC 220 turns on/off the switch element 252 every 1 ms. When the switch element 252 is turned on, the resistance value of the identification resistor 251 is set as an identification resistance value, and when the switch element 252 is turned off, a high impedance value is set as an identification resistance value. The resistance value of the identification resistor 251 is, for example, 20 kΩ.

In one example embodiment, for example, a state in which 20 kΩ is set as the identification resistance value can be assigned to the communication state H indicating the high-level digital information “1”, and a state in which the high impedance value is set as the identification resistance value can be assigned to a communication state L indicating the low-level digital information “0”. For example, by turning on/off the switch element 252 every ms by the motor drive IC 220, character string information configured of various code words such as an ASCII code or a binary code can be transmitted to the identification device 100.

For example, by turning on/off the switch element 252 in the order of “off, on, off, on, on, off, on, off”, the character string information of the ASCII code “01011010” for uppercase “Z” can be transmitted. The character string information includes information on a plurality of resistance values including 20 kΩ and a high impedance value. More specifically, the character string information is configured of digital information corresponding to an identification resistance value of 20 kΩ and digital information “0” corresponding to a high impedance value. The character string information is transmitted at a predetermined bit rate. The predetermined time interval can be determined based on the predetermined bit rate.

The character string information output from the brushless DC motor 200 is sequentially acquired using the resistance value detector 152 of the identification device 100. When the resistance value detector 152 receives the character string information of the ASCII code “01011010” for the capital letter “Z”, the identification resistance value is detected in the order of “high impedance value, 20 kΩ, high impedance value, 20 kΩ, 20 kΩ, high impedance value, 20 kΩ, high impedance value”.

For example, the ASCII code “01000001” for uppercase “A” can be assigned to the supplier A, the ASCII code “01000010” for uppercase “B” can be assigned to the supplier B, and the ASCII code “01000011” for uppercase “C” can be assigned to the supplier C. The resistance value detector 152 identifies the type of the motor by referring to the table based on the acquired character string information, that is, a plurality of resistance value groups.

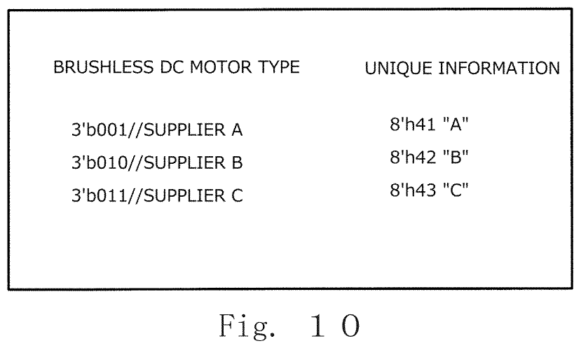

FIG. 10 illustrates a table used to identify the type of the brushless DC motor using an ASCII code as unique information. This table associates a plurality of brushless DC motor types with a plurality of ASCII codes. In this example, the ASCII code is the unique information of the brushless DC motor.

For example, after power is supplied to the brushless DC motor of the supplier A, the ASCII code “01000001” is output from the brushless DC motor. The identification device 100 can acquire the ASCII code “01000001” information and refer to the look-up table to specify that the motor to be identified is the brushless DC motor of the supplier A.

The identification resistance circuitry 250 of the brushless DC motor 200 has various other variations.

The identification resistor 251 can include a plurality of resistors connected in series or in parallel to each other. The identification resistance circuitry 250 can further include at least one switch element connected to the plurality of resistors. A resistance value group including at least one of a resistance value of each of the plurality of resistors and a combined resistance value that can be set by each of the resistance values is obtained, and information on the brushless DC motor 200 is detected based on the resistance value group by the resistance value detector 152. In other words, the resistance value detector 152 identifies information on the brushless DC motor 200 based on a change in the resistance value due to turning on/off of the switch element.

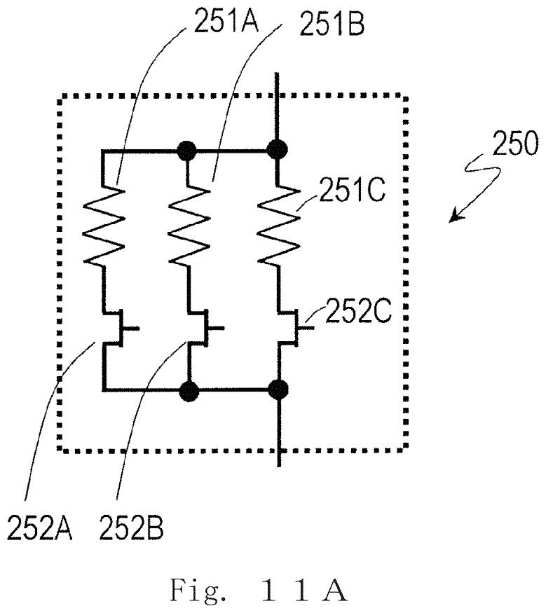

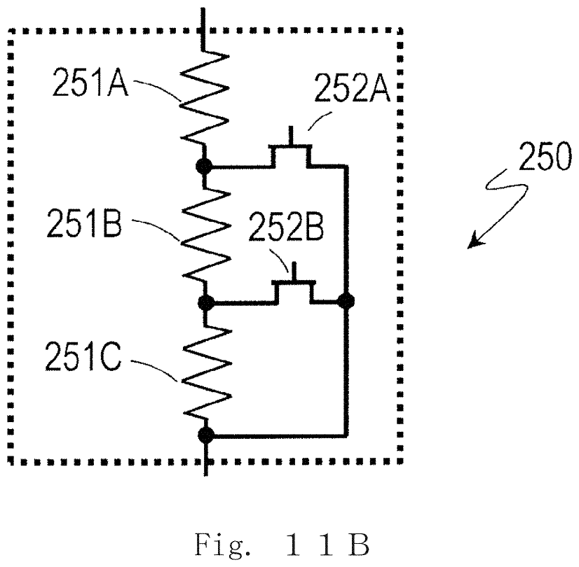

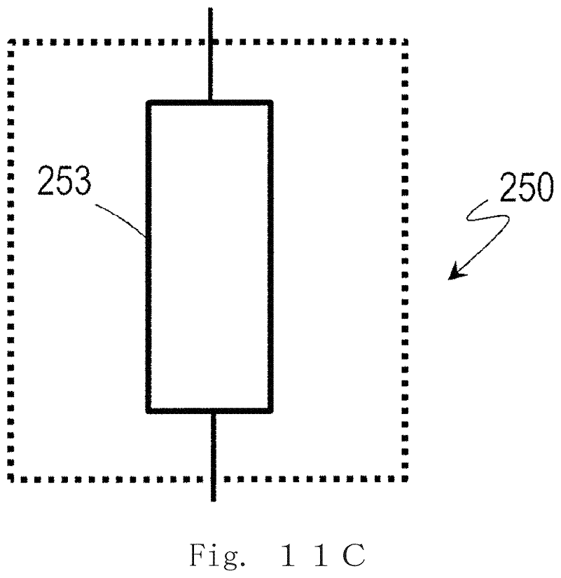

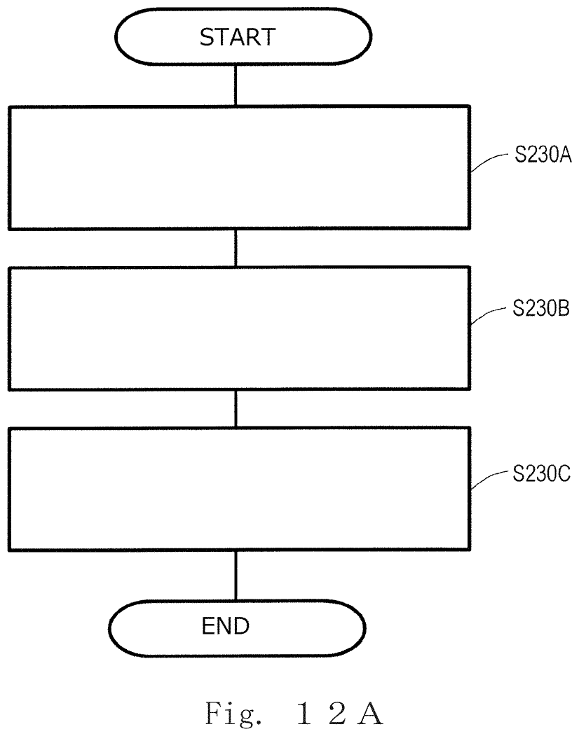

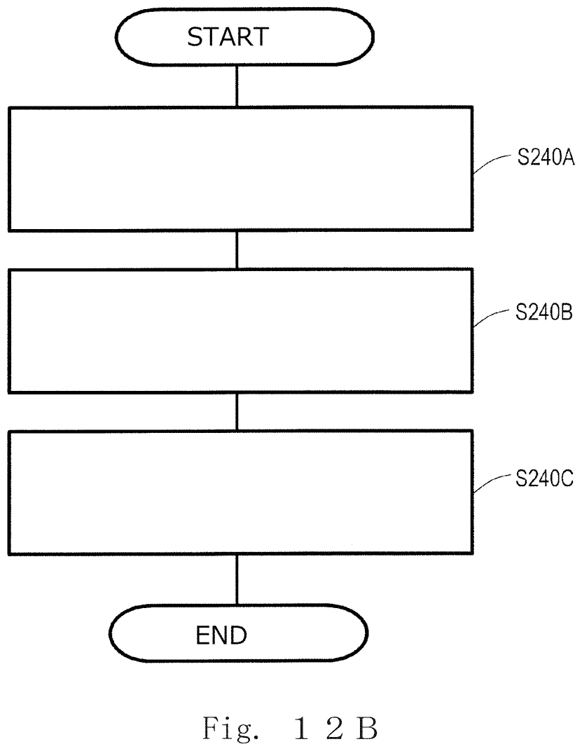

FIGS. 11A to 11C show circuit configurations of variations of the identification resistance circuitry 250. FIG. 12A is a more detailed flowchart of step S200 for reading the identification resistance value in the processing flow of the identification method for identifying the type of the brushless DC motor 200 including the identification resistance circuitry 250 shown in FIG. 11A or 11B. FIG. 12B shows a more detailed flowchart of step S200 for reading the identification resistance value in the processing flow of the identification method for identifying the type of the brushless DC motor 200 including the identification resistance circuitry 250 shown in FIG. 11C.

As shown in FIG. 11A, in one example embodiment, the identification resistance circuitry 250 has resistors 251A, 251B, and 251C that are connected in parallel with each other. A switch element 252A is connected in series to the resistor 251A, a switch element 252B is connected in series to the resistor 251B, and a switch element 252C is connected in series to the resistor 251C.

As shown in FIG. 12A, in step S200, generation of a PWM signal is stopped using the timer function of the MCU 221 of the motor drive IC 220 from the start of application of the identification power supply voltage until a predetermined time (for example, 0.1 s) elapses (step S230A).

In a state where driving of the inverter 230 is stopped, the switch elements 252A, 252B and 252C connected to the resistors 251A, 251B, and 251C are sequentially turned on (step S230B). The resistor 251A has a resistance value r1, the resistor 251B has a resistance value r2, and the resistor 251C has a resistance value r3. For example, the resistance value r1 is 20 kΩ, the resistance value r2 is 30 kΩ, and the resistance value r3 is 40 kΩ.

The resistance values r1, r2, and r3 are sequentially acquired as identification resistance values by the resistance value detector 152 of the identification device 100 (step S230C). The resistance value detector 152 can identify the type of the brushless DC motor based on a combination of the three resistance values r1, r2, and r3. Thus, the number of identifiable types can be increased by increasing the number of identification resistors.

As shown in FIG. 11B, in one example embodiment, the identification resistance circuitry 250 includes a plurality of resistors 251A, 251B, and 251C connected to each other in series. A switch element 252A is connected in series to the resistor 251A, and a switch element 252B is connected in series to the resistor 251B. One ends of the switch element 252A and the switch element 252B are connected to each other.

For example, in a state where the switch elements 252A, 252B and 252C are all turned off, a combined resistance (r1+r2+r3) of the resistance values r1, r2 and r3 is read by the resistance value detector 152. Next, in a state where the switch element 252B is turned on and the switch element 252A is turned off, a combined resistance (r1+r2) of the resistance values r1 and r2 is read by the resistance value detector 152. Finally, in a state where the switch element 252A is turned on and 252B is turned off, the resistance value r1 is read by the resistance value detector 152. The type of the brushless DC motor 200 can be identified based on the combination of the read three resistance values.

As shown in FIG. 11C, in one example embodiment, the identification resistance circuitry 250 has a variable resistance 253. For example, the motor drive IC 220 can perform control to switch the resistance value of the variable resistance 253. As shown in FIG. 12B, while driving of the inverter 230 is stopped, the resistance value of the variable resistance is sequentially switched by the motor drive IC 220, and a plurality of resistance values (resistance value group of variable resistance) set according to switching of the resistance value of the variable resistance are set to the brushless DC motor 200 (steps S240A and S240B). By sequentially reading out the plurality of resistance values by the resistance value detector 152, it is possible to identify the type of the brushless DC motor 200 based on the combination of the resistance values (step S240C).

A brushless DC motor 200 according to the present example embodiment is different from the brushless DC motor 200 according to the first example embodiment in that a switching circuit 270 is provided as means for stopping the inverter 230. Hereinafter, differences from the first example embodiment will be mainly described.

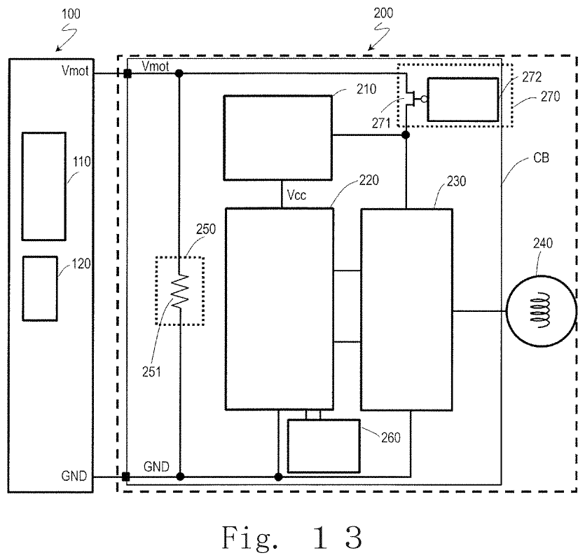

FIG. 13 schematically shows examples of typical block configurations of the user system 100 and the brushless DC motor 200 according to the present example embodiment.

The brushless DC motor 200 further includes the switching circuit 270 having a switch element 271 and an under voltage lockout circuit (UVLO) 272. The switching circuit 270 switches connection and disconnection between the power supply line and the regulator 210 or the inverter 230.

As the switch element 271, for example, a semiconductor switch element such as a unipolar transistor (MOSFET, JFET) or a bipolar transistor can be used. As the switch element 271, for example, an optocoupler, a thyristor, a mechanical relay, or the like may be used.

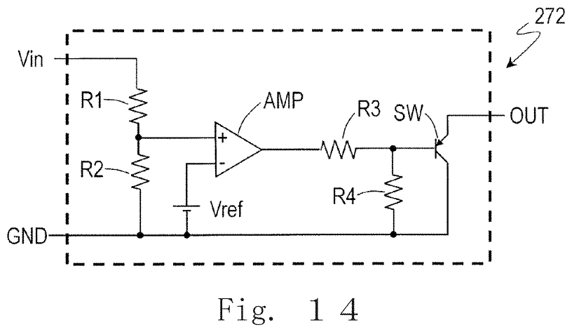

FIG. 14 shows an exemplary circuit configuration of the under voltage lockout circuit 272.

The under voltage lockout circuit 272 has, for example, a plurality of resistors R1, R2, R3, and R4, a comparator AMP, and a switch element SW. The under voltage lockout circuit 272 is connected to a power supply line. The under voltage lockout circuit 272 disconnects the inverter 230 from the power supply line when the level of the input voltage Vin supplied via the power supply line is equal to or lower than a threshold. As a result, no input voltage is supplied to the inverter 230. The threshold is set lower than the lower limit value of the range of the operating power supply voltage (for example, 7 to 13.8 V) used for normal motor driving. The threshold can be set to, for example, about 5.0 V.

The under voltage lockout circuit 272 compares the input voltage with the reference voltage Vref. The reference voltage Vref corresponds to the threshold described above. For example, when a P-type semiconductor switch element is used as the switch element 271, if the input voltage is equal to or lower than the reference voltage Vref, the under voltage lockout circuit 272 outputs a high-level voltage to turn off the switch. On the other hand, when the input voltage is higher than the reference voltage Vref, the under voltage lockout circuit 272 outputs a low-level voltage to turn on the switch element 271.

Note that, in this example, a P-type semiconductor switch element is illustrated as the switch element 271. However, an N-type semiconductor switch element, a PNP transistor, an NPN transistor, or the like may be used depending on the circuit configuration.

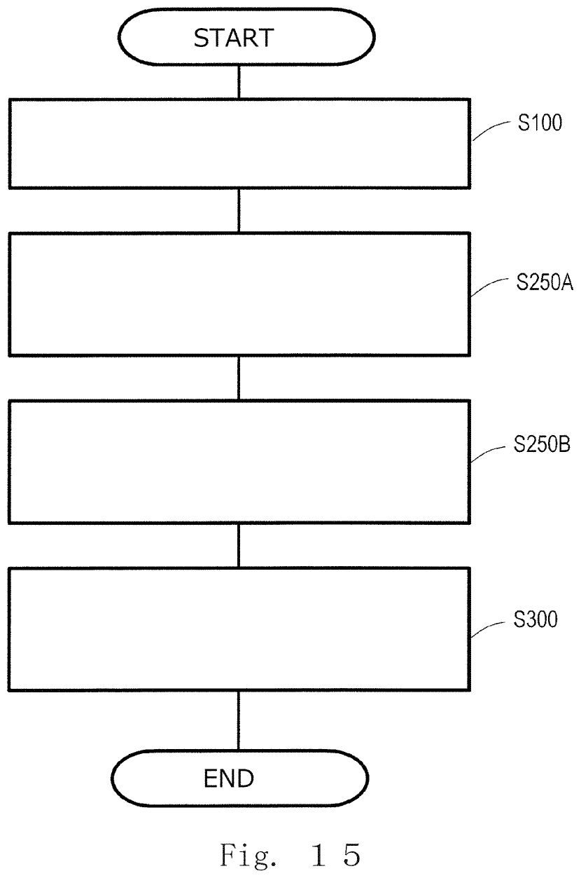

FIG. 15 shows a flowchart of an identification method for identifying the type of the brushless DC motor 200 according to the present example embodiment.

In supplying the identification power supply voltage, a level equal to or lower than the above-described threshold, that is, a low-level input voltage different from that in the normal driving, is supplied via the power supply line. The identification power supply voltage is supplied from, for example, the resistance value detector 152 (see FIG. 3) of the identification device 100. However, as described above, this may be supplied from the DC power supply 151 (see FIG. 3).

By supplying a low-level identification power supply voltage, the switching circuit 270 disconnects the inverter 230 from the power supply line. As a result, the power supply to the inverter 230 is cut off, and the inverter 230 is stopped. Since the regulator 210 is also disconnected from the power supply line by the switching circuit 270, the power supply voltage Vcc of the motor drive IC is not generated. Therefore, motor drive IC 220 also stops.

In a state where the inverter 230 is stopped, an identification current including information indicating the identification resistance value of the identification resistor 251 flows through the power supply terminal of the brushless DC motor 200. As in step S210B described in the first example embodiment, in a state where the inverter 230 is stopped, the identification resistance value is read as unique information of the brushless DC motor 200 using the identification device 100. When a low-level identification power supply voltage is applied to the brushless DC motor 200, no motor current flows through the inverter 230, but an identification current flows through the identification resistor 251 according to the identification resistance value.

The type of the brushless DC motor 200 is identified by the discriminator 153 based on the detected identification resistance value with reference to, for example, the table illustrated in FIG. 6 (step S300).

According to the identification method of the present example embodiment, unlike the conventional hand handshake, the type of the brushless DC motor 200 can be identified by reading the identification resistance value while the motor drive IC 220 (mainly the MCU 221) is not activated and the inverter 230 is stopped.

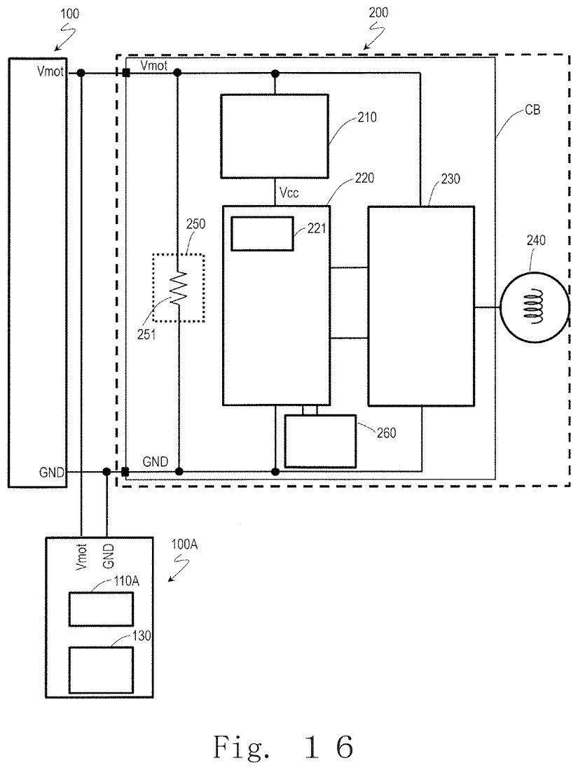

FIG. 16 schematically shows examples of typical block configurations of the user system 100, an identification device 100A, and the brushless DC motor 200.

The identification device 100A according to the present example embodiment is a device different from the user system 100, unlike the first or second example embodiment. The identification device 100A includes, for example, an MCU 110A equipped with a DC power supply 151, a resistance value detector 152, and a discriminator 153, and a light emitting element 130. Note that, for simplicity, FIG. 16 does not show the DC power supply 151, the resistance value detector 152, and the discriminator 153. The identification device 100A includes a Vmot terminal and a GND terminal as terminals necessary for identifying the type of the brushless DC motor 200.

The user system 100, the identification device 100A, and the brushless DC motor 200 are electrically connected to each other between the Vmot terminal and the GND terminal. The identification power supply voltage can be supplied from the identification device 100A to the brushless DC motor 200 via the Vmot terminal.

When the power supply is turned on, an identification current including information on the identification resistance value flows through the power supply line. The identification device 100A can identify the type of the brushless DC motor 200, for example, according to the processing flow shown in FIG. 5 or FIG. 15. The MCU 110A may transmit the identification result to the controller 110 of the user system 100.

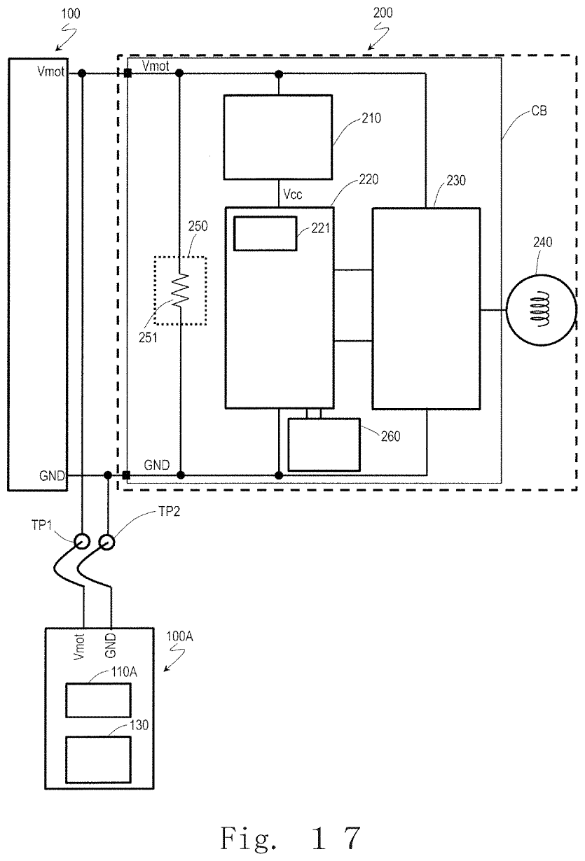

FIG. 17 schematically shows other exemplary block configurations of the user system 100, the identification device 100A, and the brushless DC motor 200.

The identification device 100A is electrically connected to the user system 100 and the brushless DC motor 200, for example, via a test point (TP). TP1 is a TP for identification power supply. TP2 is a TP for GND. A dedicated probe is connected to the identification device 100A, and the probe can be applied to the TP to identify the type of the brushless DC motor 200.

The outline of one aspect of the present disclosure is as described below.

An identification method according to an exemplary example embodiment of the present disclosure is an identification method used for an identification device that identifies information on a brushless DC motor output from the brushless DC motor. The brushless DC motor 200 includes, for example, at least one resistor 250 connected between a power supply line and a GND line, an inverter 230 that drives the motor, and a switching circuit 270 that switches connection and disconnection between the power supply line and the inverter that are shown in FIG. 13. As described with reference to FIG. 15, the identification method includes supplying the identification power supply voltage from the identification device 100 to the brushless DC motor 200 via the power supply line, disconnecting the inverter 230 from the power supply line by the switching circuit 270, reading the identification resistance value of the at least one resistor 251 in a state where driving of the inverter 230 is stopped, and identifying information on the brushless DC motor 200 based on the read identification resistance value of the at least one resistor 251. The information on the brushless DC motor 200 includes, for example, identification information of the brushless DC motor 200, serial number of the brushless DC motor 200, lot number, input power, input current, input voltage, motor temperature, rated current or rated voltage, and the like.

According to such an identification method, the identification resistance value can be read without particularly operating the MCU 221 of the brushless DC motor 200, in a state where the inverter 230 of the brushless DC motor 200 is stopped. This provides a brushless DC motor identification method capable of identifying information on the brushless DC motor without performing a handshake.

In one example embodiment, as shown in FIG. 13, the switching circuit 270 includes an under voltage lockout circuit 272 that disconnects the inverter 230 from the power supply line when the level of the input voltage is equal to or lower than a threshold. In supplying an input voltage, an input voltage of a level equal to or lower than a threshold is supplied through a power supply line. The threshold can be, for example, 5.0 V.

According to such an identification method, driving of the inverter 230 can be reliably stopped using the under voltage lockout circuit 272.

In one example embodiment, the threshold is set lower than the lower limit value of a range of the operating power supply voltage used for normal motor driving. The range of the operating power supply voltage is, for example, from 7.0 V to 13.8 V.

According to such an identification method, the inverter 230 can be disconnected from the power supply line when the input voltage is equal to or lower than the lower limit value of the range of the operating power supply voltage by using the under voltage lockout circuit 272.

In one example embodiment, the information on the brushless DC motor 200 indicates the type of the brushless DC motor 200. For example, as described with reference to FIG. 5, a unique resistance that is different for each type of the plurality of brushless DC motors is assigned to at least one resistor 251, and in reading the identification resistance value, the resistance value of the unique resistance is read by the resistance value detector 152 as unique information of the brushless DC motor 200, and in identifying the information on the brushless DC motor 200, the type of the brushless DC motor 200 is identified based on the read value of the unique resistance.

According to such an identification method, it is possible to identify the type of the brushless DC motor 200 without performing a handshake.

In one example embodiment, in identifying the type of the brushless DC motor 200, with reference to a look-up table that associates a plurality of types of brushless DC motors and pieces of unique information of the plurality of brushless DC motors, the type of the brushless DC motor 200 is identified based on the value of the read unique resistance. The look-up table is exemplified in FIG. 6, for example.

According to such an identification method, it is possible to associate the types of the plurality of brushless DC motors with pieces of unique information of the plurality of brushless DC motors using the lookup table.

In one example embodiment, the identification method further includes notifying the result of identifying the type of the brushless DC motor 200 using the identification device 100.

According to such an identification method, for example, as described above, the controller 110 of the identification device 100 may temporarily write the identification result to the memory 120, or transmit it to another apparatus or device that needs the identification result. Further, it is possible to notify the result of identifying the type of the brushless DC motor 200 using a display device (for example, a liquid crystal display) or a speaker.

In one example embodiment, the identification method further includes allowing, from among a plurality of light emitting elements 130 each assigned to each of a plurality of types of brushless DC motors, that is, a plurality of LEDs for example, a light emitting element assigned to the brushless DC motor 200 to be identified to emit light based on the result of identifying the type of the brushless DC motor.

According to such an identification method, for example, a red LED can be assigned to a supplier A, a blue LED can be assigned to a supplier B, and a green LED can be assigned to a supplier C. When the controller 110 of the identification device 100 identifies the brushless DC motor of the supplier C, the green LED is allowed to emit light.

In one example embodiment, the brushless DC motor 200 is a DC fan having an impeller, for example.

According to such an identification method, for example, the type of the brushless DC motor 200 such as an axial fan, a centrifugal fan, a cross flow fan, or a sirocco fan can be identified.

The identification device 100 according to an example embodiment of the present disclosure is an identification device that identifies information on a brushless DC motor. As described with reference to FIG. 13, the brushless DC motor 200 includes at least one resistor 251 connected between a power supply line and a GND line, the inverter 230 that drives the motor, and the switching circuit 270 that switches connection and disconnection between the power supply line and the inverter 230. The identification device 100 includes the power supply terminal Vmot for supplying an input voltage to the brushless DC motor 200 via a power supply line, and the controller 110 for identifying information on the brushless DC motor 200. As described with reference to FIG. 15, the controller 110 supplies the input voltage to the brushless DC motor 200, and in a state where the inverter 230 is disconnected from the power supply line by the switching circuit 270 to stop driving of the inverter 230, the controller reads the identification resistance value of at least one resistor 251, and identifies the information on the brushless DC motor 200 based on the read identification resistance value of at least one resistor 251.

According to such an identification device, the identification resistance value can be read without particularly operating the MCU 221 of the brushless DC motor 200, in a state where the inverter 230 of the brushless DC motor 200 is stopped. This provides a brushless DC motor identification device capable of identifying information on the brushless DC motor without performing a handshake.

As described with reference to FIG. 13, the brushless DC motor 200 according to an example embodiment of the present disclosure includes the circuit board CB, the power supply terminal Vmot for supplying an input voltage from the outside, the power supply terminal Vmot being disposed on the circuit board CB, the inverter 230 that drives the motor, at least one resistor 251 connected between a power supply line connected to the power supply terminal Vmot and the GND line, the at least one resistor 251 having a resistance value larger than the DC resistance of the motor, and the switching circuit 270 for switching connection and disconnection between the power supply line and the inverter 230, the switching circuit 270 including an under voltage lockout circuit 272 that disconnects the inverter 230 from the power supply line when the level of the input voltage is equal to or lower than a threshold. In a state where the input voltage at the level equal to or lower than the threshold is supplied via the power supply terminal Vmot and where the inverter 230 is disconnected from the power supply line by the switching circuit 270 to stop driving of the inverter 230, a current including information indicating the identification resistance value of at least one resistor 251 flows through the power supply terminal Vmot. The threshold can be, for example, 5.0 V.

According to such a brushless DC motor, the brushless DC motor 200 capable of transmitting the identification resistance value to the identification device 100, in a state where the inverter 230 of the brushless DC motor 200 is stopped, is provided.

In one example embodiment, the threshold is lower than the lower limit value of the range of the operating power supply voltage used for normal motor driving. The range of the operating power supply voltage is, for example, from 7.0 V to 13.8 V.

According to such a brushless DC motor, the inverter 230 can be disconnected from the power supply line using the under voltage lockout circuit 272.

In one example embodiment, the identification resistor 251 has a resistance value that is at least 10 times the DC resistance of the motor.

According to such a brushless DC motor, it is possible to suppress power loss due to the identification resistor 251 during normal motor driving.

Example embodiments of the present disclosure are widely used in various devices including various fan motors, such as a personal computer, a game machine, a vacuum cleaner, a dryer, a washing machine, and a refrigerator.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-12. (canceled)

13. An identification method of identifying information on a brushless DC motor output from the brushless DC motor, the identification method being used for an identification device;
the brushless DC motor including at least one resistor connected between a power supply line and a GND line, an inverter that drives a motor, and a switching circuit that switches connection and disconnection between the power supply line and the inverter, the method comprising:
supplying an input voltage from the identification device to the brushless DC motor via the power supply line;
disconnecting the inverter from the power supply line via the switching circuit;
reading a resistance value of the at least one resistor in a state where driving of the inverter is stopped; and
identifying information on the brushless DC motor based on the read resistance value of the at least one resistor.

14. The identification method according to claim 13, wherein
the switching circuit includes an under voltage lockout circuit that disconnects the inverter from the power supply line when a level of the input voltage is equal to or lower than a threshold; and
the supplying the input voltage includes supplying the input voltage of a level equal to or lower than the threshold via the power supply line.

15. The identification method according to claim 14, wherein the threshold is set lower than a lower limit value of a range of an operating power supply voltage to be used in normal motor driving.

16. The identification method according to claim 13, wherein
the information on the brushless DC motor indicates a type of the brushless DC motor;
a unique resistance is assigned to the at least one resistor, the unique resistance being different for each type of a plurality of brushless DC motors;
the reading the resistance value includes reading a value of the unique resistance by a resistance value detector as unique information of the brushless DC motor; and
the identifying the information on the brushless DC motor includes identifying the type of the brushless DC motor based on the read value of the unique resistance.

17. The identification method according to claim 16, wherein the identifying the type of the brushless DC motor includes referring to a table in which types of the plurality of brushless DC motors and pieces of the unique information of the plurality of brushless DC motors are associated with each other, and identifying the type of the brushless DC motor based on the read value of the unique resistance.

18. The identification method according to claim 13, further comprising notifying a result of identifying the information on the brushless DC motor using the identification device.

19. The identification method according to claim 16, further comprising, from among a plurality of light emitting elements assigned to respective types of the plurality of brushless DC motors, allowing a light emitting element assigned to a brushless DC motor to be identified to emit light based on the result of identifying the type of the brushless DC motor.

20. The identification method according to claim 13, wherein the brushless DC motor is a fan motor including an impeller.

21. An identification device for identifying information on a brushless DC motor,
the brushless DC motor including at least one resistor connected between a power supply line and a GND line, an inverter that drives a motor, and a switching circuit that switches connection and disconnection between the power supply line and the inverter, the identification device comprising:
a power supply terminal to supply an input voltage to the brushless DC motor via the power supply line; and
a controller that identifies information on the brushless DC motor; wherein
the controller:
supplies the input voltage to the brushless DC motor, and in a state where the inverter is disconnected from the power supply line via the switching circuit to stop driving of the inverter, reads the resistance value of the at least one resistor; and
identifies the information on the brushless DC motor based on the read resistance value of the at least one resistor.

22. A brushless DC motor comprising:
a circuit board;
a power supply terminal to supply an input voltage from outside, the power supply terminal being on the circuit board;
an inverter that drives a motor;
at least one resistor connected between a power supply line connected to the power supply terminal and a GND line, the at least one resistor having a resistance value larger than a DC resistance of the motor; and
a switching circuit to switch connection and disconnection between the power supply line and the inverter, the switching circuit including an under voltage lockout circuit that disconnects the inverter from the power supply line when a level of the input voltage is equal to or lower than a threshold; wherein
in a state where the input voltage at the level equal to or lower than the threshold is supplied via the power supply terminal and where the inverter is disconnected from the power supply line via the switching circuit to stop driving of the inverter, a current including information indicating the resistance value of the at least one resistor flows through the power supply terminal.

23. The brushless DC motor according to claim 22, wherein the threshold is lower than a lower limit value of a range of an operating power supply voltage used for normal motor driving.

24. The brushless DC motor according to claim 22, wherein the at least one resistor has a resistance value that is at least 10 times the DC resistance of the motor.

25. The brushless DC motor according to claim 23, wherein the at least one resistor has a resistance value that is at least 10 times the DC resistance of the motor.
